(19) United States
(12) Patent Application Publication
(10) Pub. No.: US 2013/0182326 A1
(43) Pub. Date: Jul. 18, 2013

(54) Lens Barrel For Zoom Lens System

(71) Applicant: Tamron Co., Ltd., Saitama-Shi (JP)

(72) Inventors: Atsushi Shimane, Koshigaya-Shi (JP); Shouko Koeda, Saitama-Shi (JP)

(73) Assignee: Tamron Co., Ltd., Saitama-Shi (JP)

(21) Appl. No.: 13/738,659

(22) Filed: Jan. 10, 2013

(30) Foreign Application Priority Data
Jan. 13, 2012 (JP) 2012-005411
Dec. 13, 2012 (JP) 2012-272142

(51) Int. Cl. G02B 7/10

(52) U.S. Cl. CPC G02B 7/10
USPC 359/557

(57) ABSTRACT

The lens barrel assembly suitable for a zoom lens comprises a pedestal barrel member secured to a mount member; a fixed barrel member secured in position closer to an object to the pedestal barrel member and having longitudinal grooves defined therein; a focus cam barrel member, a focus interlocking plate, and a first cam barrel member, each disposed inside the fixed barrel member; a second cam barrel member disposed inside any of the focus cam barrel member, the focus interlocking plate, and the first cam barrel member; a third cam barrel member disposed outside the fixed barrel member; an automatic focusing unit secured to an outer surface of the pedestal barrel member; and an anti-vibration unit disposed inside the pedestal barrel member and at least partially or completely overlapping the automatic focusing unit when the lens barrel assembly takes the position at the wide-angle end.

### FIELD OF THE INVENTION

The present invention relates to a lens barrel for zoom lens system, and more particularly, it relates to a lens barrel suitable for zoom lens system which is compatible with an imaging sensor of full frame format equivalent to 35-mm film frame format, has an automatic focusing mechanism and an anti-vibration mechanism incorporated therein, and is downsized with both the entire length and the outer diameter being reduced.

### BACKGROUND ART

Large aperture, standard zoom lenses, which are comprised of a series of four groups of lens pieces and adapted to a full frame format imaging sensor, typically have their third and fourth lens groups increased in diameter to such an extent that surplus space is not available from the middle of the lens barrel to the lens mount, which brings about difficulties in providing an anti-vibration mechanism and an ultra sonic motor incorporated focusing mechanism within the lens barrel.

Some of the prior art lens barrels for zoom lens system, which are comprised of a series of four groups of lens pieces and have an automatic focusing mechanism and an anti-vibration mechanism incorporated therein, are designed to omit a lock means dedicated to making an anti-vibration lens unable to move and also omit an actuator dedicated to driving the lock means, and are adapted to enable automatic lock/unlock control to fix/release the anti-vibration lens in exact timing, so as to attain reduced power consumption and easier handling. Such lens barrels for zoom lens system have their anti-vibration lens moved in directions other than the directions along the optical axis in the photographing optical system to compensate for unstable imaging and have their focusing lens moved for focus adjustment. For that purpose, the lens barrels typically include a focusing actuator means for moving the focusing lens. The lens barrels have an alternative lock means for fixing the anti-vibration lens in a predetermined lock position when the focusing actuator means is in a specified position, and also have a control means for activating the focusing actuator means which, in response to a signal input from a camera that urges the control means to start focusing, releases the anti-vibration lens so as to conduct focus adjustment and anti-vibration, and in response to another signal that urges the control means to terminate focusing, makes the focusing actuator means return to the specified position and fixes the anti-vibration lens in the predetermined lock position (see Patent Document 1, JP-A-H10-090587).

Also, some other prior art lens barrels for zoom lens system, which have an automatic focusing mechanism and an anti-vibration mechanism incorporated therein, are designed to be suitable for an inner focusing zoom lens of relatively small in f-number and capable of producing a bright image, and are adapted to facilitate incorporation of a holder mechanism for the lens group(s) closer to the image plane even if the lens group(s) has a larger diameter. Such lens barrels are typically for an inner focus zoom lens that comprises at least four groups of lens pieces in series, and the lens barrels have their focus cam barrel disposed inside a fixed barrel, their reciprocating barrel inside the fixed barrel, their 3rd lens group interlocked ring disposed inside the reciprocating barrel, their cam barrel disposed outside the fixed barrel, and their 1st lens group holder disposed outside the cam barrel (see Patent Document 2, JP-A-2011-039408).

In the lens barrels disclosed in Patent Document 1, the second lens group, although fixed during zooming, otherwise serves as the anti-vibration lens and the focusing lens. Hence, there arises a problem that the second lens group greater in weight and outer diameter than the third lens group is to be moved for anti-vibration and focusing. In addition, the anti-vibration mechanism and the focusing mechanism are separated, in front and behind along the optical axis, from each other, which prevents the barrel from having a reduced lengthwise dimension along the optical axis.

The lens barrel for the inner focus zoom lens disclosed in Patent Document 2 achieves the optical design compatible with APS-frame format imaging sensor. Having its focus cam barrel disposed inside the fixed barrel, its reciprocating barrel inside the fixed barrel, its 3rd lens group interlocked ring disposed inside the reciprocating barrel, its cam barrel disposed outside the fixed barrel, and its 1st lens group holder disposed outside the cam barrel, the lens barrel thus configured is adapted to facilitate incorporation of a holder mechanism for the lens group(s) closer to the image plane even if the lens group(s) has a larger diameter. Even if surplus space permits the focusing mechanism to be located in the vicinity of the lens group(s) closer to the image plane without difficulty, however, there are no other concrete statements about the position where the anti-vibration mechanism is to be located. If the anti-vibration mechanism is located in the vicinity of the second or third lens group as typical in the prior art, no solution is taught to the problem that the focusing mechanism and the anti-vibration mechanism prevent the lens barrel from having a reduced lengthwise dimension along the optical axis.

The present invention is made to overcome the aforementioned disadvantages in the prior art lens barrels for zoom lens system that have the automatic focusing mechanism and the anti-vibration mechanism incorporated therein, and accordingly, it is an object of the present invention to provide a lens barrel suitable for zoom lens system which is compatible with an imaging sensor of full frame format equivalent to 35-mm film frame format, has an automatic focusing mechanism and an anti-vibration mechanism incorporated therein, and is downsized with both the entire length and the outer diameter being reduced.

### SUMMARY OF THE INVENTION

The present invention is a lens barrel assembly suitable for a zoom lens that comprises

a pedestal barrel member secured to a mount member,

a fixed barrel member secured in position closer to an object to the pedestal barrel member and having longitudinal grooves defined therein,

a focus cam barrel member, a focus interlocking plate, and a first cam barrel member, each disposed inside the fixed barrel member,

a second cam barrel member disposed inside any of the focus cam barrel member, the focus interlocking plate, and the first cam barrel member,

a third cam barrel member disposed outside the fixed barrel member,

an automatic focusing unit secured to an outer surface of the pedestal barrel member, and

an anti-vibration unit disposed inside the pedestal barrel member and at least partially or completely overlapping the automatic focusing unit when the lens barrel assembly takes the position at the wide-angle end.

Various aspects of the present invention structured as in the above will be described as follows:

The pedestal barrel member is directly secured to the mount member.

The pedestal barrel member is secured to the mount member, with a pedestal coupling member intervening therebetween.

The automatic focusing unit includes an ultrasonic motor and a revolving ring.

The anti-vibration unit includes immobilizer members, balls, ball receptacles, and yokes.

The focus cam barrel member, the focus interlocking plate, the first cam barrel member, and the fixed barrel members are disposed in positions closer to the object than the automatic focusing unit.

The anti-vibration unit is disposed inside the second cam barrel member.

### Effects of the Invention

The lens barrel assembly suitable for a zoom lens according to the present invention is compatible with an imaging sensor of full frame format equivalent to 35-mm film frame format, has an automatic focusing mechanism and an anti-vibration mechanism incorporated therein, and is downsized with both the entire length and the outer diameter being reduced.

### BRIEF DESCRIPTION OF THE DRAWINGS

FIG. 1 is a sectional view showing an exemplary lens barrel assembly suitable for a zoom lens according to the present invention taking the position at the wide-angle end.

FIG. 2 is a sectional view showing the exemplary lens barrel assembly for a zoom lens according to the present invention taking the position at the telephoto end.

FIG. 3 is an expansion plan view showing a fixed barrel with longitudinal grooves as a member of the exemplary lens barrel assembly for a zoom lens according to the present invention.

FIG. 4 is an expansion plan view showing a focus cam barrel as a member of the exemplary lens barrel assembly for zoom lens according to the present invention.

FIG. 5 is an expansion plan view showing a first cam barrel as a member of the exemplary lens barrel assembly for a zoom lens according to the present invention.

FIG. 6 is an expansion plan view showing a second cam barrel as a member of the exemplary lens barrel assembly for a zoom lens according to the present invention.

FIG. 7 is an expansion plan view showing a third cam barrel as a member of the exemplary lens barrel assembly for zoom lens according to the present invention.

### BEST MODE OF THE INVENTION

The present invention will now be described in the context of embodiments of a lens barrel assembly for a zoom lens, with reference to the accompanying drawings.

Hereinafter, the term ‘groove’ as in ‘cam groove’ means an aperture defined by cutting out the circumferential wall of a barrel member till the barrel member is partially radially clear like a slit, so as to serve as part of a cam linkage. The term ‘recess’ as in ‘guide recess’ means a sunken portion that has the bottom and is radially not clear unlike a slit.

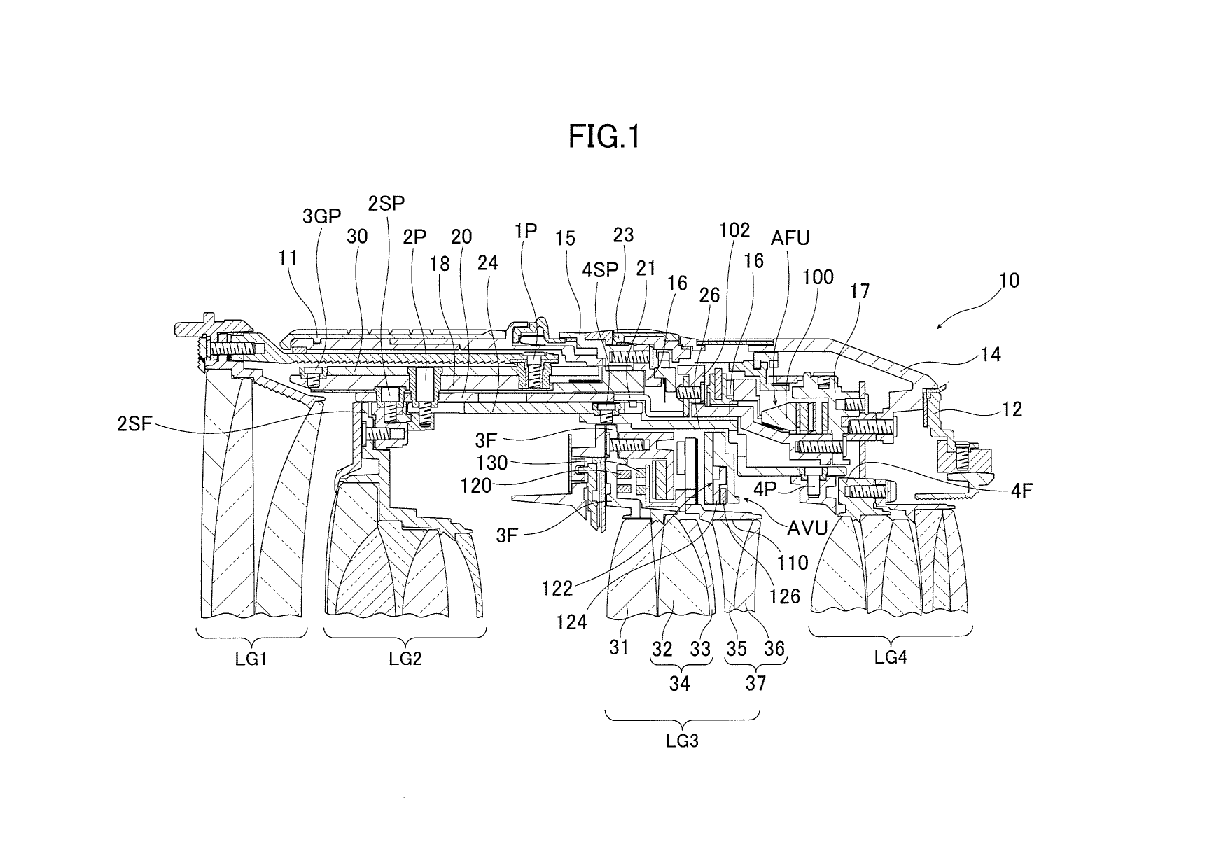

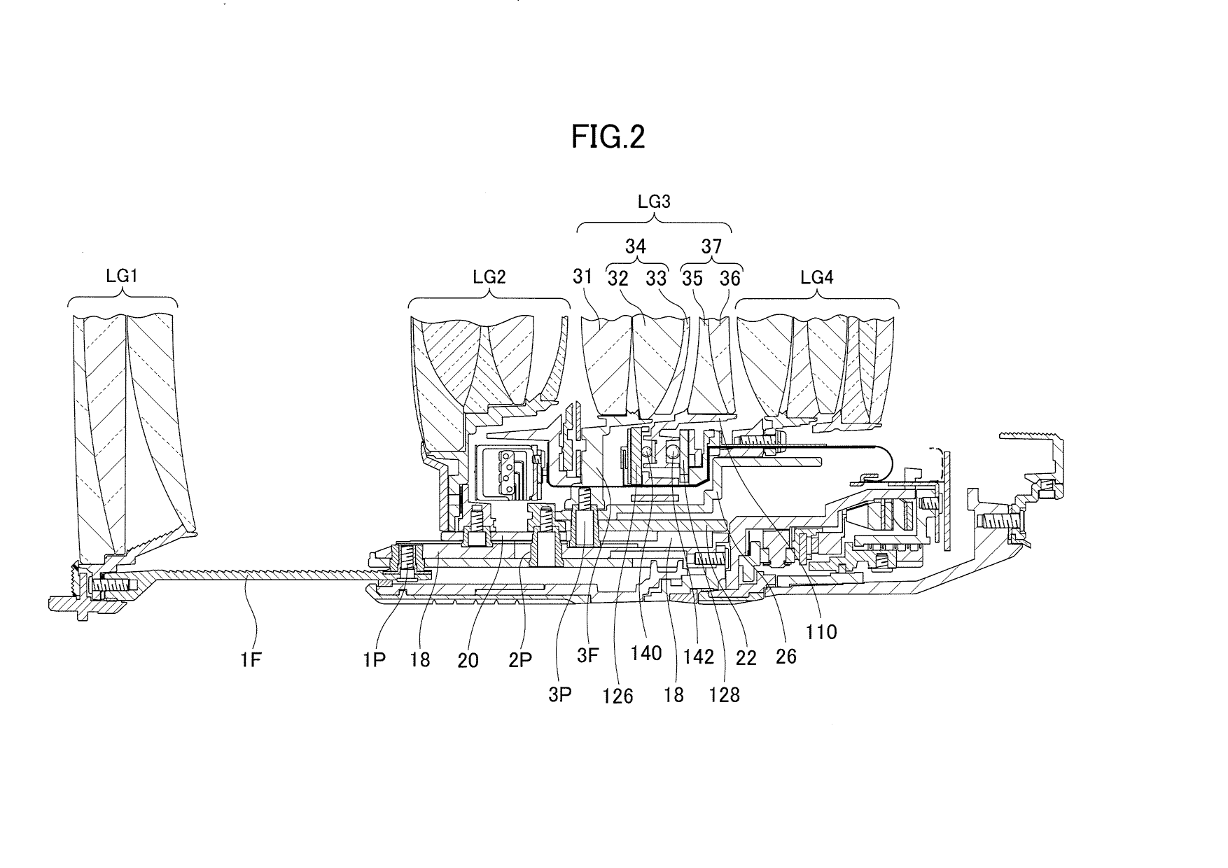

A lens barrel assembly 10 suitable for a zoom lens includes, as shown in FIGS. 1 and 2, the foremost or first lens group LG1 closest to an object, the succeeding second lens group LG2, the third lens group LG3, and the fourth lens group LG4 arranged in series. The second lens group LG2 is the one used for focusing. The third lens group LG3 includes the foremost lens subset 3-1 closest to the object and of a single lens piece 31 of positive refractivity, the succeeding lens subset 3-2 of a composite or cemented lens 34 of positive refractivity that consists of a positive lens piece 32 and a negative meniscus lens piece 33 bonded together, and the rearmost or third lens subset 3-3 of a composite or cemented lens 37 of negative refractivity that consists of a negative lens piece 35 and a positive meniscus lens piece 36 bonded together. The composite or cemented lens 37 in the lens subset 3-3 serves as an anti-vibration lens.

The lens barrel assembly 10 includes a lens mount 12, and first and second outer barrel members 14, 15 that are substantially integrated with the lens mount 12. The first outer barrel member 14 is secured to the lens mount 12. A pedestal barrel member 16 is secured to the lens mount 12 with a pedestal interlocking member 17 intervening therebetween. A fixed barrel member 18 provided with longitudinal grooves is secured to the second outer barrel member on the side closer to the object. Herein, any person having ordinary skills in the art could envision the configuration in which the pedestal barrel member 16 is directly secured to the lens mount 12.

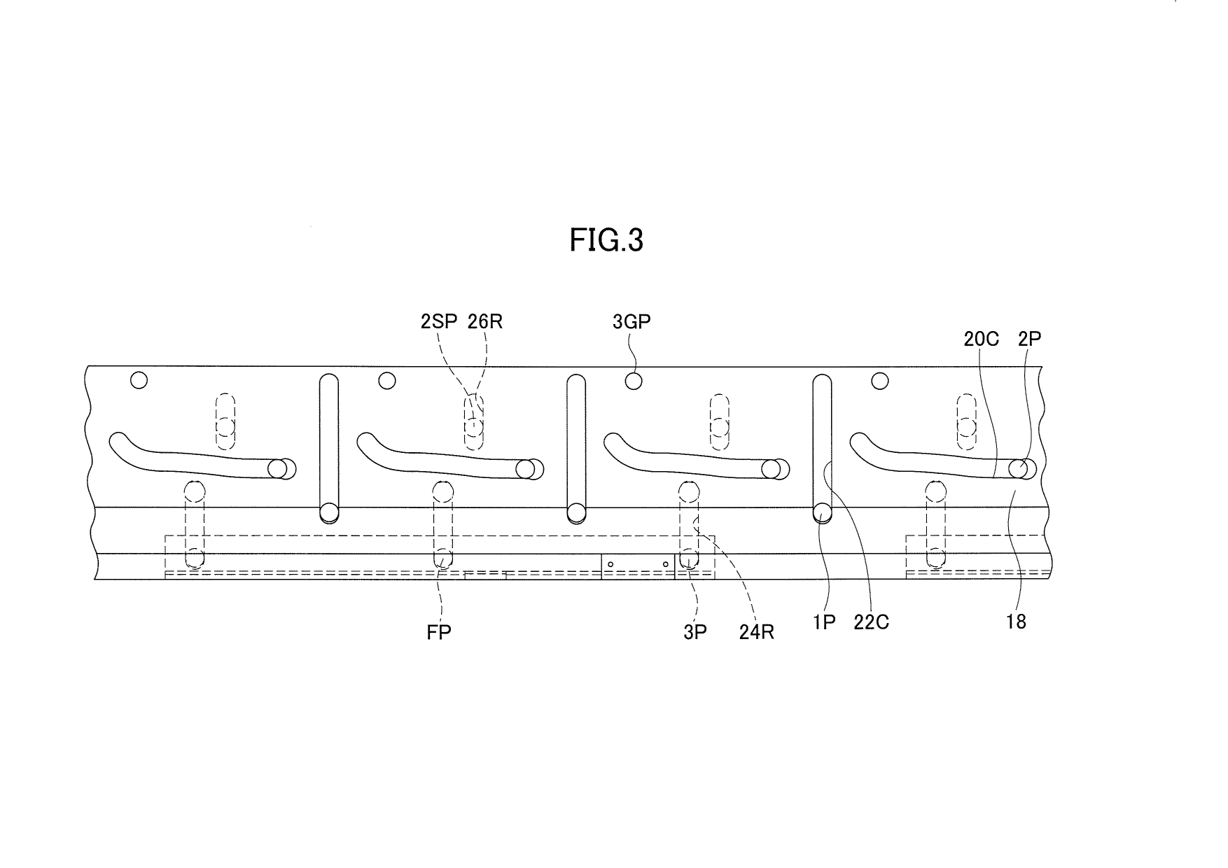

As can be seen in FIG. 3, zoom cam grooves 20ZC in relation with the second lens group and guide grooves 22C in relation with first lens group for their rectilinear movement are respectively defined in the fixed barrel member 18. The fixed barrel member 18 has it outer surface provided with guide pins 3GP that inhibit a third cam barrel member 30 from moving beyond toward the object. The fixed barrel member 18 has its inner surface provided with guide recesses 24R in relation with the third lens group LG3 for their rectilinear movement and guide recesses 26R in which pins are guided to slide rectilinearly along with the second lens group coupled thereto.

Pins 2P provided in a slidable frame 2SF for sliding movement along with the second lens group are fitted in the cam grooves 20ZC so as to move the second lens group LG2 for zooming. Pins 1P provided in a 1st lens group holding frame 1F are fitted in the guide grooves 22C so as to move the first lens group LG1 non-revolvingly and rectilinearly. Pins 3P provided in a 3rd lens group holding frame 3F are fitted in the guide recesses 24R so as to move the third lens group LG3 non-revolvingly and rectilinearly. Slidable pins 2SP coupled to the second lens group LG2 are fitted in the guide recesses 26R so as to slide along with the second lens group LG2 non-revolvingly and rectilinearly.

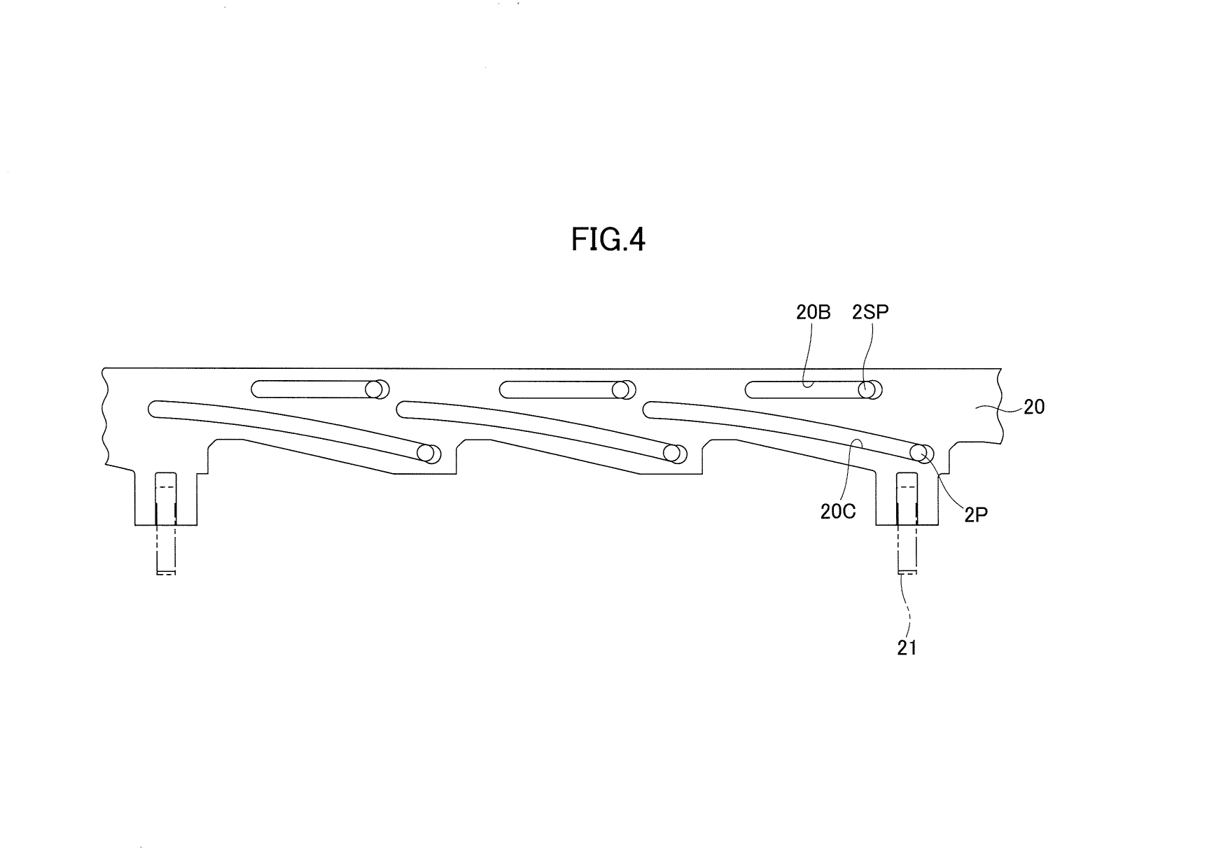

As can be seen in FIGS. 1 and 2, a focus cam barrel member 20 is disposed inside the fixed barrel member 18. As can be seen in FIG. 4, the focus cam barrel member 20 has cam grooves 20C for focusing motion of lens pieces and grooves 20B in which the slidable pins 2SP are fitted for sliding movement along with the second lens group LG2 coupled thereto. The focus cam barrel member 20 is connected to a revolving ring 102 of an automatic focusing unit AFU detailed later, with a focus interlocking plate 21 intervening therebetween.

The pins 2P coupled to the second lens group LG2 are fitted in the cam grooves 20C so as to move the second lens group LG2 for zooming. The slidable pins 2SP coupled to the second lens group LG2 are fitted in the grooves 20B so as to slide along with the second lens group LG2 for focusing.

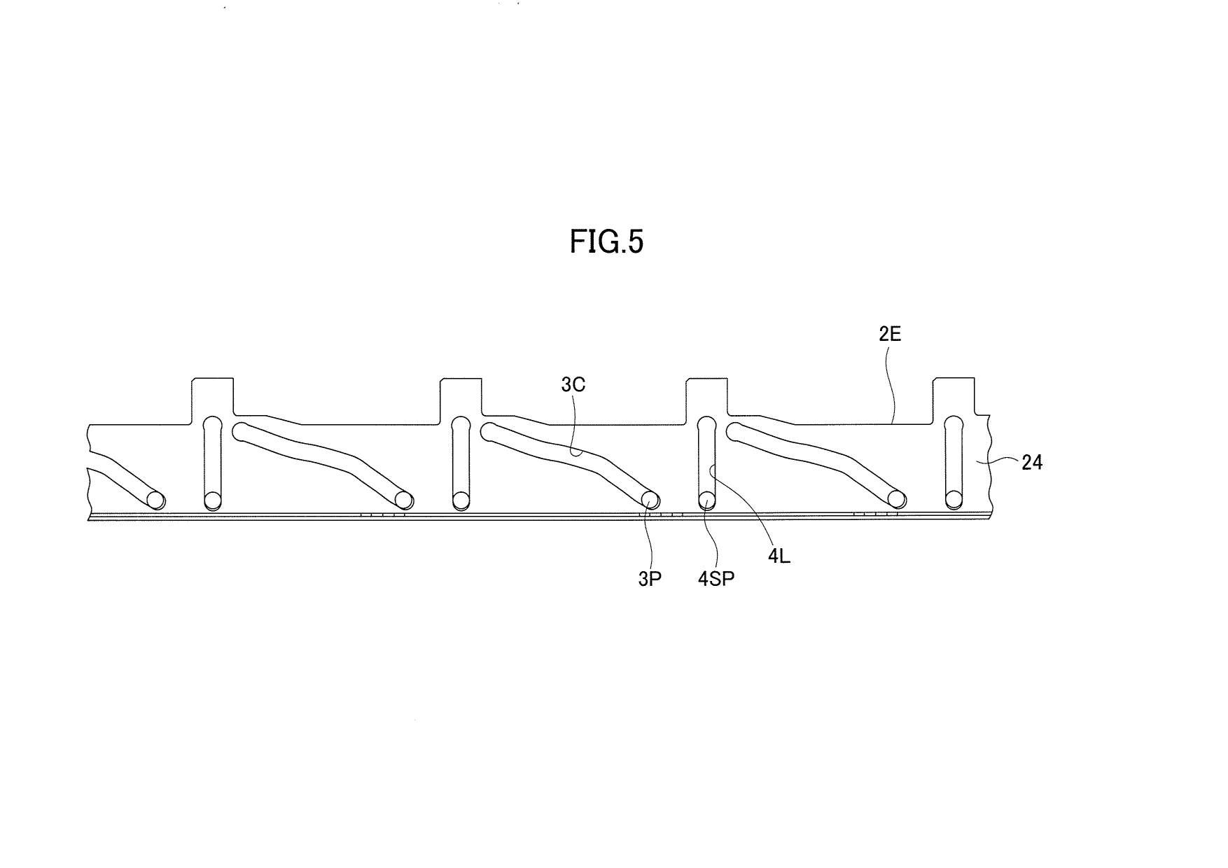

As can be seen in FIGS. 1 and 2, a first cam barrel member 24 is disposed inside the focus cam barrel member 20. As can be seen in FIG. 5, the first cam barrel member 24 has cam grooves 3C serving as part of a cam linkage in relation with the third lens group LG3 and longitudinal grooves 4L in relation with the fourth lens group LG4. The pins 3P in the 3rd lens group holding frame 3F are fitted in the cam grooves 3C so as to move the third lens group LG3 for zooming. Slidable pins 4SP provided in a second cam barrel member 26 are fitted in the longitudinal grooves 4L and guided in parallel with the optical axis O so as to slide along with the fourth lens group LG4 for zooming. The first cam barrel member 24 has notches 2E each circumferentially elongated so as not to disturb the rotation of the pins 2P coupled with the second lens group LG2.

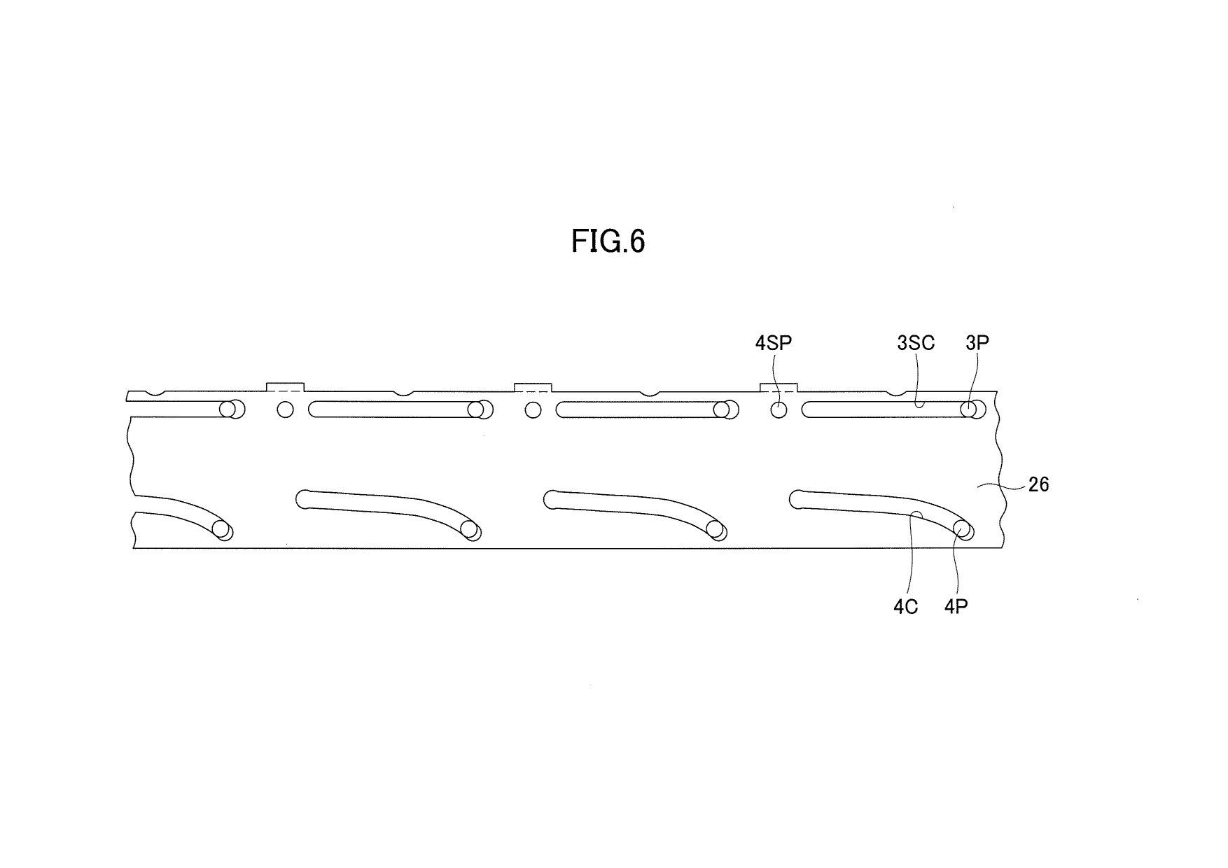

As can be seen in FIGS. 1 and 2, the second cam barrel member 26 is disposed inside the first cam barrel member 24. As can be seen in FIG. 6, the second cam barrel member 26 has slide grooves 3SC in which the pins 3P provided in the 3rd lens group holding frame 3F are fitted so as to slide along with the third lens group LG3, and cam grooves 4C serving as part of a cam linkage in which pins 4P provided in a 4th lens group holding frame 4F are fitted.

Revolving movement of the 4th lens group holding frame 4F is restrained by the pins 4P provided in the 4th lens group holding frame 4F and grooves (not shown) in relation with the fourth lens group 4LG for their rectilinear movement, and these grooves are defined as a functional member substantially integrated with the 3rd lens group holding frame 3F.

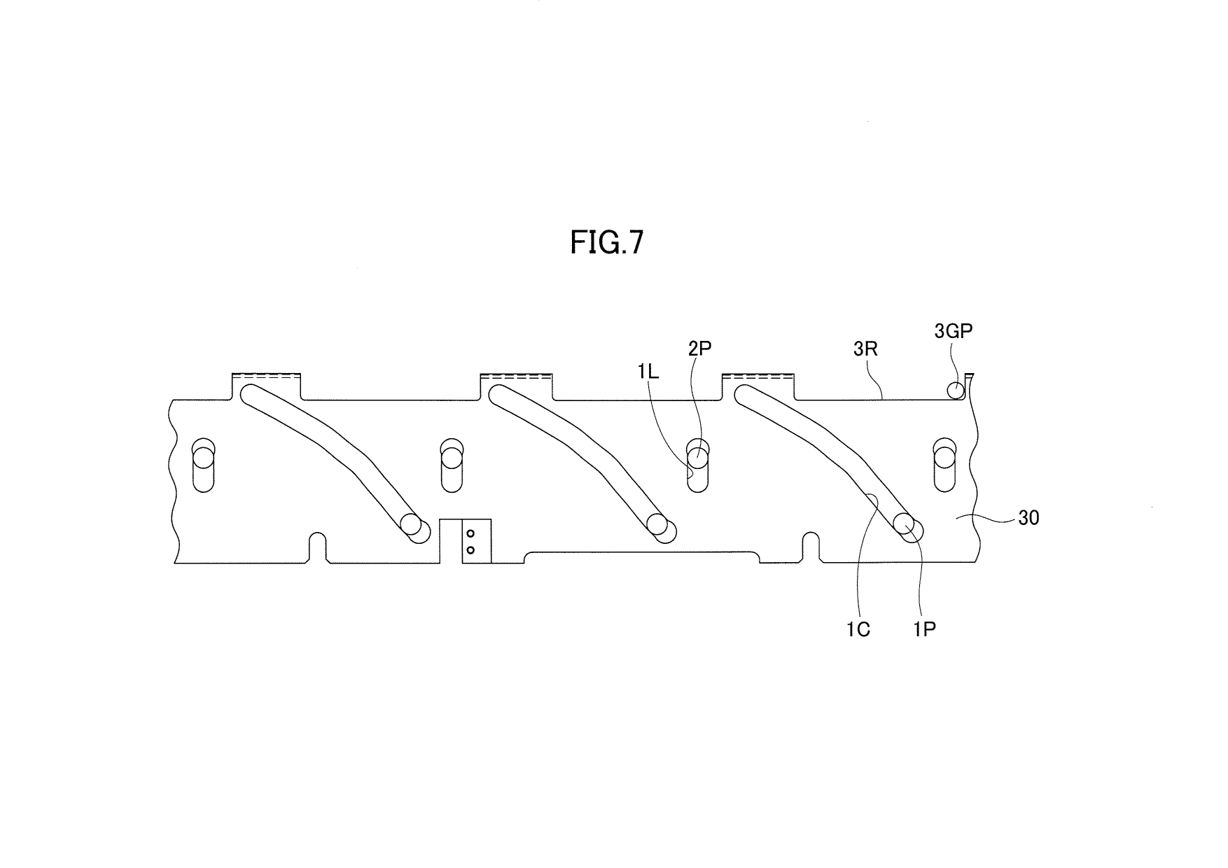

As can be seen in FIGS. 1 and 2, the third cam barrel member 30 is disposed outside the fixed barrel member 18. As can be seen in FIG. 7, the third cam barrel member 30 has cam grooves 1C serving as part of a cam linkage in relation with the first lens group LG1. The pins 1P provided in the 1st lens group holding frame 1F are fitted in the cam grooves 1C so as to slide along with the first lens group LG1 for zooming. The third cam barrel member 30 has longitudinal grooves 1L in which the pins 2P coupled with the second lens group LG2 are fitted in. Additionally, the third cam barrel member 30 has guide grooves 3GR in which guide pins 3G are fitted in so as to guide the third cam barrel member 30.

### <Zooming>

Revolving movement of a zoom ring 11 is transmitted to the third cam barrel member 30. The pins 1P provided in the 1st lens group holding frame 1F are fitted in the guide grooves 22C defined in the fixed barrel member 18 to rectilinearly slide along with the first lens group LG1 and also fitted in the cam grooves 1C provided in the third cam barrel member 30 to serve as part of a cam linkage with the first lens group LG1. Revolving movement of the third cam barrel member 30 permits the first lens group LG1 to non-revolvingly and rectilinearly move for zooming.

Revolving movement of the zoom ling 11 is also transmitted to the first cam barrel member 24. The pins 2P in a 2nd lens group holding frame 2F are fitted in the zoom cam grooves 20ZC defined in the fixed barrel member 18 to serve as part of a cam linkage with the second lens group LG2 and also fitted in the longitudinal grooves 1L defined in the third cam barrel member 30. Moreover, the slidable pins 2SP provided in the 2nd lens group holding frame 2F are fitted in the grooves 20B defined in the focus cam barrel member 20 so as to slide along with the second lens group LG2 and also fitted in the guide recesses 26R defined in the fixed barrel member 18 for rectilinearly guiding the pins to slide along with the second lens group LG2. Thus, revolving movement of the first cam barrel member 24 permits the focus cam barrel member 20 to non-revolvingly and rectilinearly move, and permits the frame 2F and the second lens group LG2 held by the same to non-revolvingly and rectilinearly move for zooming.

The pins 3P in the 3rd lens group holding frame 3F are fitted in the guide recesses 24R defined in the fixed barrel member 18 so as to move the third lens group LG3 rectilinearly and also fitted in the cam grooves 3C defined in the first cam barrel member 24 so as to serve as part of a cam linkage with the third lens group LG3. Revolving movement of the first cam barrel member 24 permits the frame 3F and the third lens group LG3 held by the same to move non-revolvingly and rectilinearly for zooming.

The pins 4P in the 4th lens group holding frame 4F are fitted in the cam grooves 4C defined in the second cam barrel member 26 so as to serve as a cam linkage with the fourth lens group LG4 and also fitted in the longitudinal grooves 4L defined in the first cam barrel member 24. Revolving movement of the first cam barrel member 24 is transmitted to the second cam barrel member 26, which permits the 4th lens group holding frame 4F and the fourth lens group LG4 held by the same to move non-revolvingly and rectilinearly for zooming.

### <Focusing>

Revolving movement of a manual focusing ring 23 is transmitted to the revolving ring 102. Revolving movement of a focusing ring 50 is transmitted to the focus cam barrel member 20, with the focus interlocking plate 21 intervening therebetween. By virtue of the pins 2P fitted in both the cam grooves 20C and the longitudinal grooves 1L, the 2nd lens group holding frame 2F and the second lens group LG2 held by the same are permitted to move non-revolvingly and rectilinearly for focusing.

### <Automatic Focusing Unit AFU>

As can be seen in FIGS. 1 and 2, a well-known automatic focusing unit AFU is disposed over an outer surface of the pedestal barrel member 16. The automatic focusing unit AFU includes an ultrasonic motor 100 activated by a focusing signal received from a camera (not shown), and the revolving ring 102. The focusing ring 50 may be revolved manually (by hand) by virtue of the manual focusing ring 23.

### <Anti-Vibration Unit AVU>

The lens piece 31 in the lens subset 3-1 and the cemented lens 34 in the lens subset 3-2 respectively in the third lens group LG3 are directly held by the frame 3F. The frame 3F also holds the cemented lens 37 in the lens subset 3-3, with the anti-vibration unit AVU and another frame 110 intervening therebetween. The anti-vibration unit AVU moves from a position where the zoom lens is at the wide-angle end shown in FIG. 1 to another position at the telephoto end shown in FIG. 2, with regard to the directions along the optical axis O. When the lens barrel assembly is set in the position where the zoom lens is at the wide-angle end shown in FIG. 1, the automatic focusing unit AFU and the anti-vibration unit AVU are almost layered one over another within a certain extension along the optical axis.

As depicted in FIG. 1, the anti-vibration unit AVU includes a magnet 120 substantially secured to the 3rd lens group holding frame 3F, and an immobilizer unit 122 similarly substantially secured to the 3rd lens group holding frame 3F. The immobilizer unit 122 includes an immobilizer wheel 124 and immobilizer arms 126, and when the anti-vibration unit AVU is electrically disconnected, the immobilizer wheel 124 is rotated, and the immobilizer arms 126 hold the cemented lens 37 in the lens subset 3-3. Coil 130 is connected to the frame 110 holding the cemented lens 37 in the lens subset 3-3. The coil 130 is located between the magnet 120 and the immobilizer unit 122 and separated from either of them.

The frame 110 to which the magnet 120 is secured is movable in directions perpendicular to the optical axis within a certain range although pinched by balls 140, 142 between a pair of fixing yoke members 126, 128 substantially secured to the 3rd lens group holding frame 3F as shown in FIG. 2.

The coil 120 is supplied with coil driving electric power depending upon a vibration detection signal produced from a gyro (not shown) that is located in position within the lens barrel assembly 10 and detects vibration of the same. The coil 130 supplied with the coil driving electric power is moved to a predetermined position in a direction perpendicular to the optical axis by magnetic power from the magnet, so that the cemented lens 37 in the lens subset 3-3 compensates for the vibration.

1. A lens barrel assembly suitable for a zoom lens, comprising
a pedestal barrel member secured to a mount member,
a fixed barrel member secured in position closer to an object to the pedestal barrel member and having longitudinal grooves defined therein,
a focus cam barrel member, a focus interlocking plate, and a first cam barrel member, each disposed inside the fixed barrel member,
a second cam barrel member disposed inside any of the focus cam barrel member, the focus interlocking plate, and the first cam barrel member,
a third cam barrel member disposed outside the fixed barrel member,
an automatic focusing unit secured to an outer surface of the pedestal barrel member, and
an anti-vibration unit disposed inside the pedestal barrel member and at least partially or completely overlapping the automatic focusing unit when the lens barrel assembly takes the position at the wide-angle end.

2. The lens barrel assembly suitable for a zoom lens according to claim 1, wherein the pedestal barrel member is directly secured to the mount member.

3. The lens barrel assembly suitable for a zoom lens according to claim 1, wherein the pedestal barrel member is secured to the mount member, with a pedestal coupling member intervening therebetween.

4. The lens barrel assembly suitable for a zoom lens according to claim 1, wherein the automatic focusing unit includes an ultrasonic motor and a revolving ring.

5. The lens barrel assembly suitable for a zoom lens according to claim 1, wherein the anti-vibration unit includes immobilizer members, balls, ball receptacles, and yokes.

6. The lens barrel assembly suitable for a zoom lens according to claim 1, wherein the focus cam barrel member, the focus interlocking plate, the first cam barrel member, and the fixed barrel members are disposed in positions closer to the object than the automatic focusing unit.

7. The lens barrel assembly suitable for a zoom lens according to claim 1, wherein the anti-vibration unit is disposed inside the second cam barrel member.
